(19) United States
(12) Patent Application Publication
(10) Pub. No.: US 2009/0177975 A1
(43) Pub. Date: Jul. 9, 2009

(54) IMAGE DESIGN SYSTEM

(75) Inventors: Adam Elgar, London (GB); Tom Elgar, London (GB); Andrew Christian Camargo Francis, London (GB); Andrew Cox, London (GB)

Correspondence Address: MCDERMOTT WILL & EMERY LLP, 18191 VON KARMAN AVE., SUITE 500, IRVINE, CA, 92612-7108, US

(73) Assignee: Serverside Group Limited, London (GB)

(21) Appl. No.: 12/293,276

(22) PCT Filed: Mar. 16, 2007
(86) PCT No.: PCT/GB2007/000923

§ 371 Date: Oct. 22, 2008

(30) Foreign Application Priority Data
Mar. 16, 2006 (GB) 0605390.4

(51) Int. Cl. G06F 3/00; G06F 15/16; G06F 7/00

(52) U.S. Cl. 715/751; 709/206; 707/104.1; 707/E17.001

(57) ABSTRACT

A computer implemented image design facility capable of supporting image design by a plurality of users each having browser-based access, comprising: an image design engine capable of presenting an image design interface to a plurality of users via browser software on user computers, said image design engine comprising means for storing image designs resulting from a plurality of user design processes as a corresponding plurality of uniquely identifiable sessions; and a messaging engine to construct an electronic message to a new user identified by an existing one of said plurality of users, said messaging engine being coupled to said image design engine such that it receives session information relating to an image design produced by said existing user and intended by that user to be accessed by said new user.

### FIELD OF THE INVENTION

The present invention relates to methods and apparatus for image design, including computer systems, software and methods of the operating same.

### BACKGROUND

A process for manipulating images is described in PCT/GB04/000626, which is incorporated herein by reference. As illustrated in FIG. 10 a customer enters the front end software 805. The customer chooses an image 807—in FIG. 10 from the customer's computer hard drive 806, and uploads it to the image compilation server 808.

The image 807 could come from any suitable source such as an image library maintained by an operator of the image compilation server 808. Back end software 810, running on the image compilation server 808, now enters the original image into a database and generates a less computationally demanding (e.g. a web-friendly) copy 811 to send to the front end software 805. The customer now performs image manipulations 812 (such as resizing, rotating, and placing the image), as the customer desires.

The back end software 810 associates the customer image selection, and subsequent manipulations and selections, with the unique customer identifier 803. Next, the customer chooses another image 813 to overlay on top of the first image 807, and positions image 813 as desired. The overlay image 813 may, for example, be a transparent decorative frame for the uploaded image 807, and may be maintained in an image server 814. The back end software 810 transmits a web-friendly, smaller version 815 of the overlay image 813 to the customer, for use in creating a combination 816 of the original manipulated image 807 with the overlay image 813.

Once customer approval 817 of the final design 816 is achieved and indicated to the front end software 805, the front end software 805 transmits a string of user image manipulation data 818 to the image compilation server 808. This string 818 defines the customer's image selections and manipulations. On receiving this string 818 the back end software 810 accesses the original copies of the images from an image library and performs the exact operations that the customer has chosen in the front end software 805 for the customer's final design. In this way, the back end software 810 emulates the manipulations at the user end according to the information transferred in the text string (also referred to herein as the results script and image manipulation parameters). At this point the back end software 810 can output the resulting image 819 to a printer server 820, which may be performed through a firewall 821. The resulting image 819 and associated customer identifier 801 may then be passed to the bank (or other card issuer) printer server 809, which in turn accesses the financial account association table 825 to obtain the associated secure customer financial data 826.

The financial data 826 and resulting image 819 may then be sent to a credit card printer 822, which prints a customized credit card 823. All of the images that are used by the customer in the front end software 805 are issued via the back end software 810. In certain embodiments, the only information which passes to the back end software 810 from the front end software 805 (apart for requests for images) is data about how the image in front of the customer appears. This information can easily be encrypted for increased security. The number of images combined in a design is not limited to one or two (such as images 807 and 813)—the script can be easily amended for many more layers. Also, transparent frame image layers need not be selected and manipulated before a non-transparent image layer; the image layers can be designed in any order.

Text can also be added to the image through a similar replication. The output image can be sent to any type of machine and thus the possible applications are very wide-ranging: the software can be applied not only to the payment card market, but also for non-payment and telephone cards or other image-bearing products. In certain embodiments, layers may be employed as templates and/or marks, referred to herein as transparencies. In one embodiment, the final image displayed on a card may be restricted to a selected pre-defined area, such as a “window” on a payment card (or other financial account access means), leaving the rest of the card free to contain functional features of the card, such as a bank logo, a payment card hologram or type indicator (such as, for example, “Visa” or “MasterCard” logos).

Alternatively, some image layers may be positioned within such a selected window on the card; while other image layers (such as transparencies) are positioned outside the selected window, but surrounding the functional features of the card (such as the bank logo, payment card hologram, etc.). Also, the bank logo or other financial feature can act as a fixed template, behind which the user can move the image to a desired position.

This enable customers to design their own transaction card. However, a problem associated with this process is that each customer must directly access the software, and are not able to receive other peoples opinions about their card design without that other person being able to view their display screen.

Therefore, a process is required which enables customers to share their manipulated images with other user, such that other user can use the same image or can further manipulate the image.

### SUMMARY

According to an aspect of the present invention, there is provided a computer implemented image design facility capable of supporting image design by a plurality of users each having browser-based access, comprising:
an image design engine capable of presenting an image design interface to a plurality of users via browser software on user computers, said image design engine comprising means for storing image designs resulting from a plurality of user design processes as a corresponding plurality of uniquely identifiable sessions; and
a messaging engine to construct an electronic message to a new user identified by an existing one of said plurality of users, said messaging engine being coupled to said image design engine such that it receives session information relating to an image design produced by said existing user and intended by that user to be accessed by said new user.

Preferably the image design facility comprises an image store for storing base images and an image parameter store for holding image manipulation parameters defining manipulations applied to the image during image design sessions of users.

According to another aspect of the present invention, there is provided a method of designing an image involving a plurality of users each having access to an image design facility via a browser-based interface on a user computer, the method comprising:
providing a first user with browser-based access to the image design facility in a first session;
receiving an indication of one or more new users from said first user with whom the first user intends to share an image design of said first session;
generating a saved session defining said image design of said first session; and
automatically generating an electronic message to said one or more new users, the or each message comprising a link to said image design facility and saved session information capable of directing the or each new user to the image design of said first user as defined in said saved session.

In the disclosed embodiment, a product of a design session is stored in a form comprising a base image component and separate image manipulation parameters, the combination of which defines the designed image. Preferably, these elements are linked by association with a unique identity of the session.

Preferably, the saved session has a unique session identity which is independent from a unique session identity of the first user session. Still more preferably the saved session is generated responsive to an indication the first user intends to share an image design with a new user.

In a preferred embodiment, the or each new user accessing the image design facility responsive to receipt of an email is provided with a further unique session identity such that the or each user can independently define an image design to be shared with other users.

Thus, several versions of the same image design may exist at any given time in the form of different sessions. Also a session may comprise an open session or a saved session which in effect holds the state of a previously open session. A saved session may be used as the basis of a subsequently opened (future) session, although in such circumstances the subsequently opened session is preferably associated with a new unique identity.

According to another aspect of the present invention, there is provided a method for designing the fascia of a transaction card over a communications network, the method comprising:
opening a first design session between a first user terminal and a host computer over the communications network;
sending a first set of commands in the first design session from the first user terminal for affecting a computer program executed on a host computer for designing the fascia;
assigning an identifier for identifying said first session; and
forwarding the identifier to a second user terminal for opening a second session for affecting the fascia designed in the first session.

According to another aspect of the invention, there is provided a server for hosting a user interface arranged to interact with a plurality of user terminals for designing a fascia of a transaction card, the server comprising:
means arranged to receive instructions from the user terminals;
means for establishing a first session with at least one of the user terminals and for executing the instructions received therefrom for designing a fascia;
a database for storing a copy of data corresponding to the design of the fascia in the first session;
a generator for generating a link to the copy of the data of the first session; and
a messaging engine for forwarding the link to at least one other user terminal for enabling the at least one other user terminal to access the copy of the data of the first session for designing a fascia.

According to another aspect of the present invention, there is provided a data structure in a database for storing data relating to a plurality of designed images, the database comprising:
a first store for storing a plurality of base images;
a second store for storing sets of parameters, each parameter set defining manipulations applied to a base image; and
a session identifier store associating a session identifier with at least a base image and a set of parameters, which combination defines a designed image.

According to another aspect of the present invention, there is provided a method of designing an image comprising emailing a link to a stored session, the method comprising:
establishing a first session with a first user terminal, wherein image design data is generated in response to commands from the first user terminal;
storing an email address of an email account belonging to at least one other user;
storing said image design data as well as storing a copy of said image design data; and
generating a link identifying the copy of said image design data in an email to said email account.

According to another aspect of the present invention, there is provided a method of accessing image design data in a saved session responsive to receipt of an electronic message to a new user comprising a link to said image design data, the method comprising generating a new session based on said saved session and allocating a new session identifier to said new session.

Preferably, a new session based on said saved session is generated for each new user and each new session is provided with an independent session identifier.

Preferably, sessions related to a given email chain are related (or “linked”) to each other in the database.

According to an aspect of the present invention, there is provided a method of proliferating competitive image designs, comprising:
providing a first user with browser-based access to an image design facility;
receiving an indication of one or more new users from said first user with whom the first user intends to share an image; and
generating an email including a link to, or representation of, the first user's image, said email further including a link to, or representation of, further competitive images.

According to an aspect of the present invention, there is provided a computer implemented image design facility capable of supporting image design by a first user having browser-based access, the image design facility comprising:
an image design engine capable of presenting an image design interface to the first user via browser software on the first users computer, and comprising a storage device for storing first user image design data produced by the first user during a first image design session; and
a messaging engine coupled to the image design engine such that it receives the first user image design data, and capable of constructing an electronic message to a second user identified by the first user, the electronic message comprising a link enabling the second user to access the first user image design data.

Preferably, a first session identifier is associated with the first user image design data.

Preferably, the storage device further comprises:
a session identifier store for storing the first session identifier.

Preferably, the first user image design data comprises:
image data defining a base image; and
image parameter data defining manipulations applied to the base image during the first image design session.

Preferably, the storage device further comprises:
an image store for storing the base images; and
an image parameter store for storing the image parameter data.

Preferably, the image parameter data comprises x and y positioning data, scale data, flip data and/or rotation data

Preferably, the base images comprises stock images and/or uploaded images uploaded by the first user.

Preferably, the storage device further comprises:
a user address store for storing an address of the second user identified by the first user.

Preferably, the electronic message is an email.

Preferably, the electronic message is an Instant Message.

Preferably, the electronic message is SMS.

Preferably, the messaging engine is capable of generating a version of the first user image design based on the first user image design data for inclusion in the electronic message.

Preferably, the version of the first user image design is a web friendly version of the first user image design.

Preferably, the link enables the second user to access the computer implemented image design facility and edit the first user image design during a second image design session to produce a second user image design.

Preferably, the link enables the second user to access the computer implemented image design facility and create a second user image design during a second image design session.

Preferably, a second session identifier is associated with the second user image design.

Preferably, the first user image design data includes data relating the second session identifier to a first session identifier associated with the first user image design data.

Preferably, accessing the link generates the second session identifier.

Preferably, the electronic message comprises the second session identifier generated by the messaging engine.

Preferably, the second session identifier is related to the first session identifier

Preferably, the link is embedded in the electronic message.

Preferably, the link is encrypted.

Preferably, accessing the link generates the first image design using image data defining a base image and image parameter data defining manipulations applied to the base image during the first image design session.

Preferably, the link enables the second user to access images uploaded by the first user.

Preferably, the first user image design is a non-finalised first user image design.

Preferably, the computer implemented image design facility further comprises:
an accept/reject unit for determining if the first user image design is acceptable, and if the first user image design if not acceptable, then the message engine generates an electronic message to the first user informing the first user that the first user image design is not acceptable.

Preferably, the first user image design is applied to a transaction card.

Preferably, the second user image design is applied to a transaction card.

According to an aspect of the present invention, there is provided a computer implemented message engine for constructing an electronic message to a second user identified by a first user, said computer implemented message engine comprising:
an electronic message generation unit for generating the electronic message comprising information relating to a first user image design produced by the first user for access by the second user.

Preferably, the computer implemented message engine, further comprises
an image generation unit for generating a version of the first user image design based on first user image design data and including the generated version of the first user image design in the electronic message.

Preferably, the information relating to a first user image design comprises a link enabling the second user to access the first user image design.

Preferably, the information relating to a first user image design comprises image data defining a base image, and image parameter data defining manipulations applied to the base image during a first image design session.

Preferably, the information relating to a first user image design further comprises a first session identifier.

Preferably, the computer implemented message engine further comprises:
a session identifier unit for generating a second session identifier associated with the second user.

Preferably, the second session identifier is related to the first session identifier. Preferably, the first user image design is applied to a transaction card.

According to an aspect of the present invention, there is provided a method of designing an image involving a plurality of users, the method comprising:
providing a first user with access to an image design facility for creation of a first image design and associating a first session identifier with the first image design;
providing a second user with access to the image design facility and information relating to the first image design associated with a second session identifier;
enabling the second user to edit the first image design associated with the second session identifier to produce a second image design; and
enabling the first user to edit the first image design associated with the first session identifier.

Preferably, the first image design comprises image data defining a base image, and image parameter data defining manipulations applied to the base image by the first user.

Preferably, the second image design comprises image data defining a base image, and image parameter data defining manipulations applied to the base image by the second user.

Preferably, wherein the image data and the and image parameter data are associated with the session identifier.

### BRIEF DESCRIPTION OF THE DRAWINGS

For a better understanding of the invention and as to how the same may be carried into effect reference will now be made, by way of example only, to the accompanying drawings, in which:

FIG. 1 illustrates a process flow diagram of one embodiment of the invention;

FIG. 2 illustrates a process flow diagram of one embodiment of the invention;

FIG. 3 illustrates an overview of flows between a client/server, an User 1 and an User 2;

FIG. 4 illustrates several card designs together with user comments;

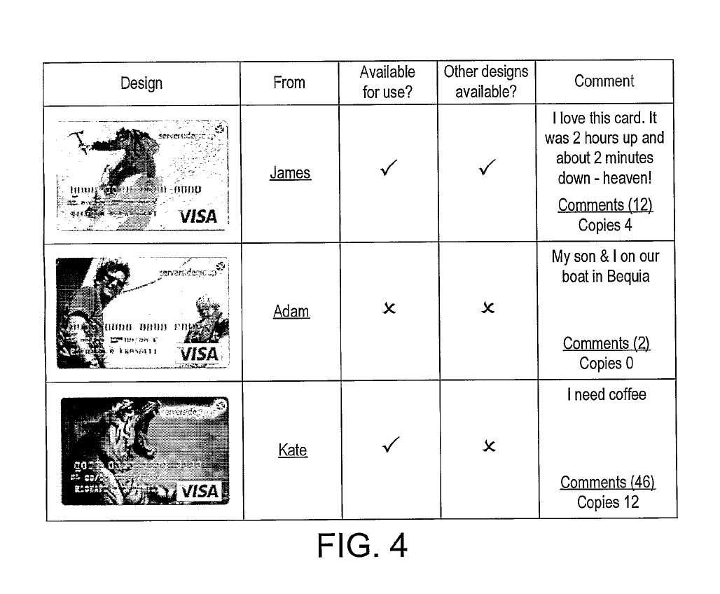

FIG. 5 illustrates an exemplary web page through which a user can select and manipulate an image;

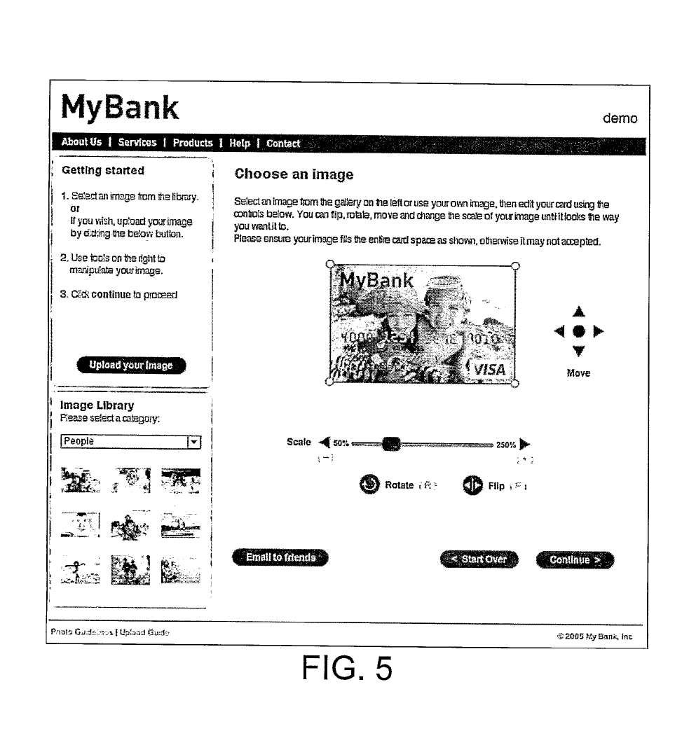

FIG. 6 illustrates an exemplary web page used by a user to send a card image design to a friend;

FIG. 7 illustrates an exemplary web page used by a user to send a card image design to a plurality of friends;

FIG. 8 illustrates a process a flow diagram of another embodiment of the invention;

FIG. 9 illustrates a process a flow diagram of another embodiment of the invention;

FIG. 10 illustrates a process a flow diagram of another embodiment of the invention;

FIG. 11 illustrates a process a flow diagram of another embodiment of the invention;

FIG. 12 illustrates a process a flow diagram of another embodiment of the invention;

FIG. 13 illustrates an overview of flows between a client/server, an User 1 and an User 2;

FIG. 14 illustrates an interface illustrating a card design; and

FIG. 15 illustrates a process flow diagram of an embodiment of the invention.

### DETAILED DESCRIPTION

A process of the invention allows financial card design software (or other image design software) to “go viral” on the Internet. There are two related methods disclosed within this document:

The first is one that works upon the passing of session data via an encrypted URL of some form; the method of dispersement of the URL could be email, Instant Messaging (IM) or webpage (whether HTML or dynamically generated). In order to be able to achieve this end a user should be able to forward the link of a website to their friends. In the system described below the link that they can forward can include information that allows the user to “share” their session. This means that “friends” of the initial user can see the designs that the initial user has made and make their own cards based on the initial user's uploaded images. It is, therefore, in some senses, a file sharing application but more than that it allows the sharing of the designs while they are still in a ‘live’ and re-definable state. Session data, including the image or part designed image, is stored in a particularly efficient manner as described in embodiment 1 and 2 below.

The business value of this system is that it allows the image design facility to ‘go Viral’—it is open, easy and fun and therefore has the potential to be used and forwarded via email or a similar messaging system. By allowing the design to remain live the experience lives on through multiple sessions thereby enhancing the value of the customer experience. This greatly increases the potential value of the base card designer product. A series of scenarios in which this product may be used are included later in this document.

The second is simply using a pre-generated design that again can be dispersed using email, IM or webpage. In this instance the benefit is by allowing users to create ‘stock’ cards. This may be of little interest to major brands which spend millions on the image of their company and the cards being a very large part of that brand experience. However, for affinity groups or for niche products produced by those major brands, which are less brand conservative and are also actively seeking involvement from their members, this offers a rare and exciting opportunity.

In both cases there are two methods of attracting the response. Firstly, via direct one-to-one solicitation, which is to say by a user forwarding, or otherwise ‘soliciting’ a ‘friend’. The obvious method to achieve this is a mail/message format such as email, SMS or Instance Messenger. The second method is via solicitation through an affinity network—this could include the affinity organisation's website, an affinity listing website, a ‘blog’ or message board or otherwise. This second version is therefore less ‘viral’ as it is not forwarded from one user to another but nonetheless embraces one of the major aspects of modern usage of the internet; namely user generated content.

As stated above an image design created by a user consists of image data and user selected parameter data, which details manipulations applied to the image by the user.

According to a first embodiment a user can enter a friends email address and an email is automatically sent to the friend (second user) with an embedded (and possibly also encrypted) link within the email. The link will include information that allows the image design system to link the second user (when the email is linked) to the session of the first user. In this way the second user can see the images that have been uploaded by the first user. However the second user will not have the same session as the first but a new session, the images that they can see are the same but the system will assign a new session ID to the second user so that the system knows that there are two different individuals involved.

It will also be possible for the second user to see the designs that the first user is working on and the design that the first user is contemplating saving. The first user sends the email at a ‘preview’ (i.e. not finalized) stage of the design in a preferred embodiment.

At various points the database saves the various parameters held by the designer (in a preferred embodiment, a Flash movie) and thereby holds ‘state’ on the design that the user has made. Image manipulation parameters that define manipulations and for example the positioning applied to the image (on the card) are saved to a database. In particular the image manipulation parameters will hold data such as the x and y positioning, scale, flip and rotation, though other parameters may be saved in addition or in the alternative. When a new user logs in using the same or a related login/session ID the design (card design) can be recreated using the manipulation parameters saved to the session that the user picks up.

Images uploaded by the first user after the email has been sent may or may not be viewable by the second user as they access the site. In this embodiment the system will create a new set of references to the images uploaded by the first users and thereby make two sessions which do not interact.

In an additional embodiment however the second user may inherit a shared pool of images so that their additions (through uploaded images) are visible to the first user and to any other users that may have access to the session. All users can have access to all the images uploaded by any other user, or to any other user in the same email chain.

### Embodiment 1

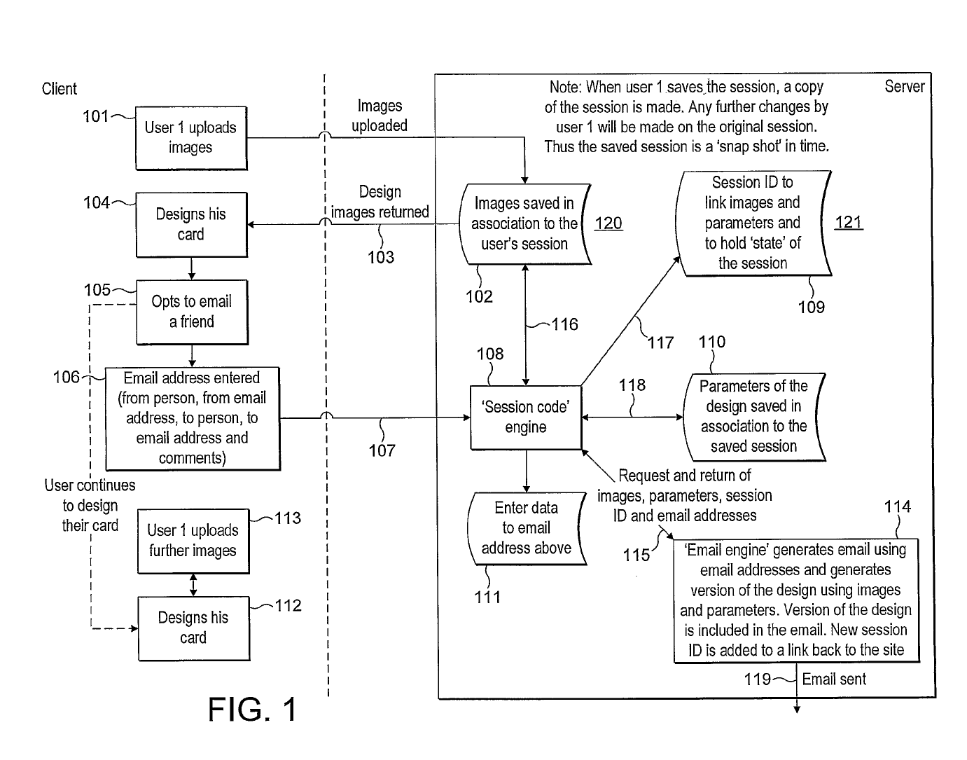

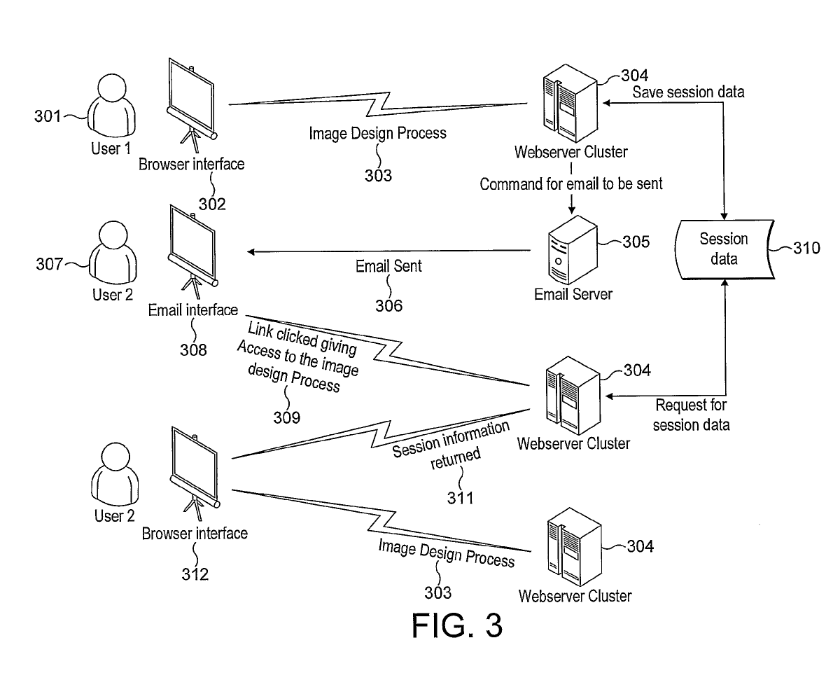

The key feature of embodiment 1 is that the email system is held on the server. FIGS. 1, 2 and 3 all refer to this architecture. As illustrated in FIG. 1, initially User 101 may upload images to image store 102 of an image design facility. It would also be possible that the images are already resident in the image store 102 and are held as stock or library (pre-approved) images. The images are held in association to the user's web session 120 (this web session could be held as a cookie or a part of the URL or in other formats).

User 101 is then passed design sized images (via HTTP or HTTPS as in all cases of client/server interaction within this specification unless defined otherwise) of the uploaded image or of the selected image from the image library at 103. User 101 can design their card using manipulation tools such as flip, rotate, size and move 104. In the preferred embodiment this will be delivered through a Flash movie interface within a Flash plugin or JavaScript front-end.

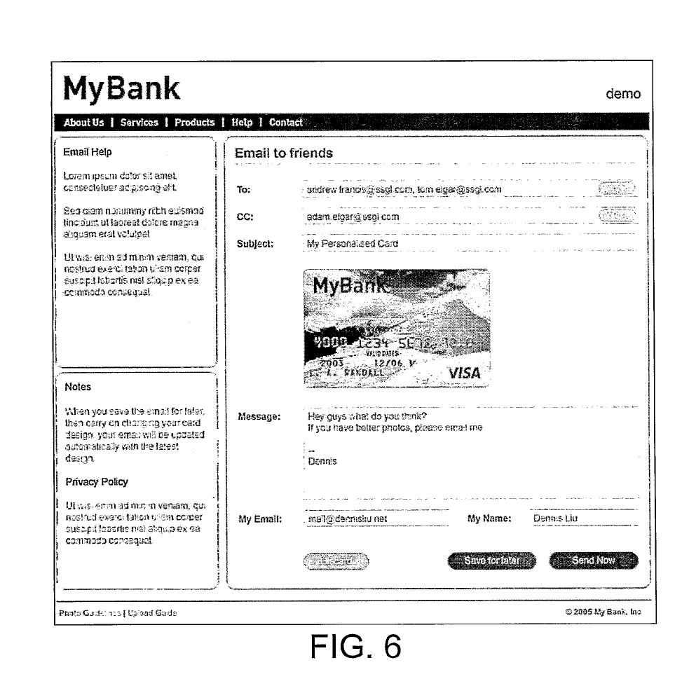

The user can opt to send an email to a “Friend” 105. This will cause the image design facility to produce a series of text boxes 106 for presentation to the user which will include at least the option to add an email address as illustrated in FIG. 6. This email address will be of the friend. Other information that User 101 may enter may include their name, their email address and any comments that they have about the design. It is possible that several email addresses will be entered and possibly a comment to each of the new users.

The information is passed to the server through an internet-based communication method such as XML or HTML 107. The information can include the session ID, the email addresses, comments, the parameters of the design (image ID, x and y positioning etc).

This information is saved 108 in to the various data stores—the email address store 111, the design parameter store 110 and a new session ID is generated 121 in the session ID store 109 that is linked to these stores.

In the meantime User 101 can continue to design their card 112 with their original session. Thus at this point there are two sessions in existence—the initial session and the saved session 121. The saved session is fixed and the initial session can still be changed. The User 101 can also upload new images—but they will not be referenced in session 121 only in the initial session.

It is possible that the User 101 can trigger the email to be sent to another user but in the preferred embodiment the email will be launched by a scheduled “service” shortly after the information has been saved. This will ensure scalability for the email function.

The email engine 114 generates an email 119 to be sent to another user via the email address saved in the email address store 111. The information for the email is captured via the ‘Session Code’ engine 108 which captures the image 102, the parameters of the design 110, the new session ID 109 and the email addresses 111 and any user comments all associated with the saved session.

The email engine will then generate a small version of the design—including the branding, association marks, embossing etc—so that the design is representative of the finished cards. This card design is included in the email along with the comments from User 101 and a link back to the website that contains the new session ID 109 of the saved session. The email will be sent to all of the email addresses that have been added.

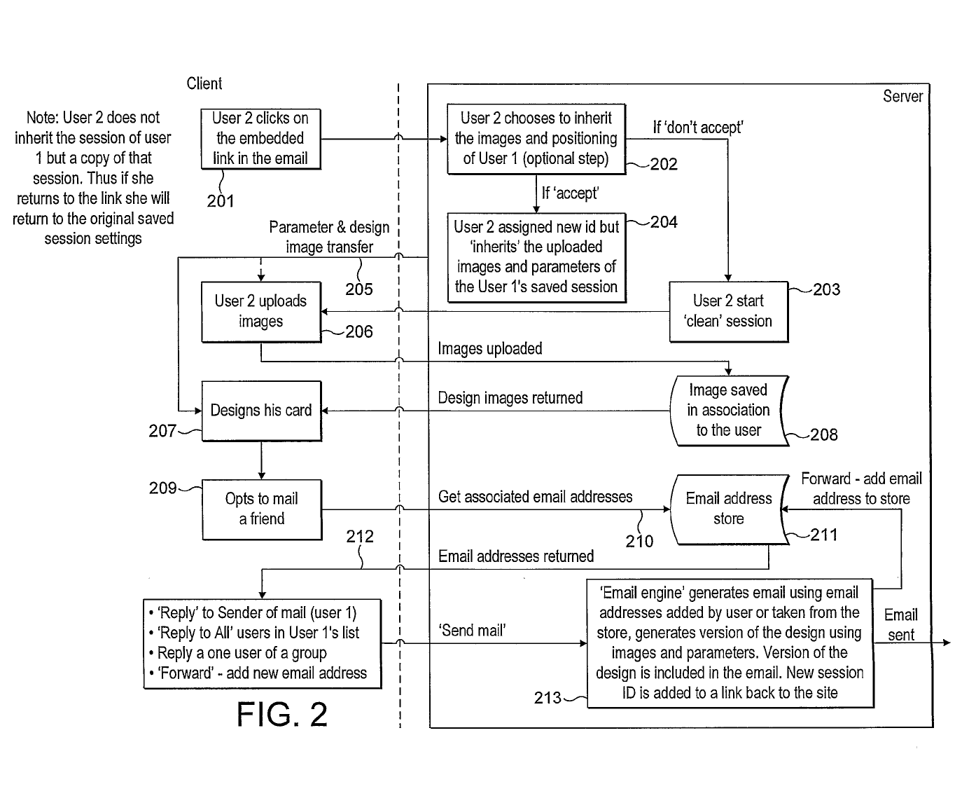

As illustrated in FIG. 2, the email 109 is sent and arrives in the email account of User 201. User 201 clicks on the link and in this embodiment is directed to a page that asks—“Would you like to inherit the images and designs of your friend?” 202. This is an optional step.

If the answer is “No” then the user is given a new clean session 203 and can begin to create new image designs. If the answer is “Yes” then the system will assign a new session ID 204 that inherits the settings of the saved session. This ensures that more than one new User can use the link and create new sessions. In this scenario User 201 could forward their email direct from their email package to another User who could click on the same link but both User 201 and the new user would inherit the same information but would have separate sessions and separate session ID's.

The parameters and images are transferred at 205 and returned to User 201. At this point the User 201's client machine receives the parameters and the images and recreates the design that the User 101 saw at the point she pressed “Send to a Friend”. Further images which User 101 had uploaded would be available to User 201 and can be selected. In a preferred embodiment these images would be made available through a special “My Images” panel within the Card Designer interface.

The User 201 can use the card designer to design their card or can upload their own images using the upload page 206. If images are uploaded they are stored at the image store 208/102. Design images are then created and returned to the image designer 207.

The User 201 can save his card design at any point and have a new design with a new ID associated with it.

However the User 201 may now wish to email a friend as well 209. FIG. 2 suggests that there is a request to the server at 210 to the email store 211 and that the email addresses are returned 212 but information could be transferred at 204/205.

User 201 has several options once the email list has been returned to her. Reply to sender, Reply to all, Forward, Reply to any member in the group or add a new email address.

The email engine 213/114 then generates the mail in the same way as previously and includes the image as previously. There is a new comment included as below and a link back as before. This will save the session as is described earlier.

It is preferably possible for the user to clear images from their session. The images will not be deleted as they may be required in a separate session but the links to the images within the session data will be removed.

It should be possible for User 101 to set a parameter which will be passed within the data passed at point 107 which will allow them to either show or hide their uploaded images from the ‘friend’. This will be stored as a parameter of the session at 121.

By creating a relationship stored within the session store 121 and related to the design parameter store 110 the system can hold multiple designs within a session and so the user can return to a previous design. By forwarding the designs to a Friend 201, the Friend 201 can also inherit these designs.

It is preferably also possible, using the same architecture, for the User 101 to save a design until later. This can work in a functionally similar way to the send to a friend example. In this scenario User 101 will click on a link “Save my design until later”—by entering their own email address at this point the User 101 can be sent an image (with or without their design image) which will have a link back to their design session.

There are two options:
1. the User ‘saves’ their session to the session store. The session is actually held as a new session i.e. a new session that inherits the attributes of the first session. This would thereby create a ‘snapshot’ in time. An email is sent that is linked to this second session.
2. the User ‘saves’their session but actually the session is not replicated but a “click” to the present session is emailed to the User. If further changes are made (designs made, images uploaded) then they will be stored within this initial session.

### Embodiment 2

The key feature of embodiment 2 is that the email system is held on the users/client machine.

As with embodiment 1 the second embodiment stores the session data on the servers so that the ‘Friend’ can use the same design or images within their session. The difference is that it works through the clients email system.

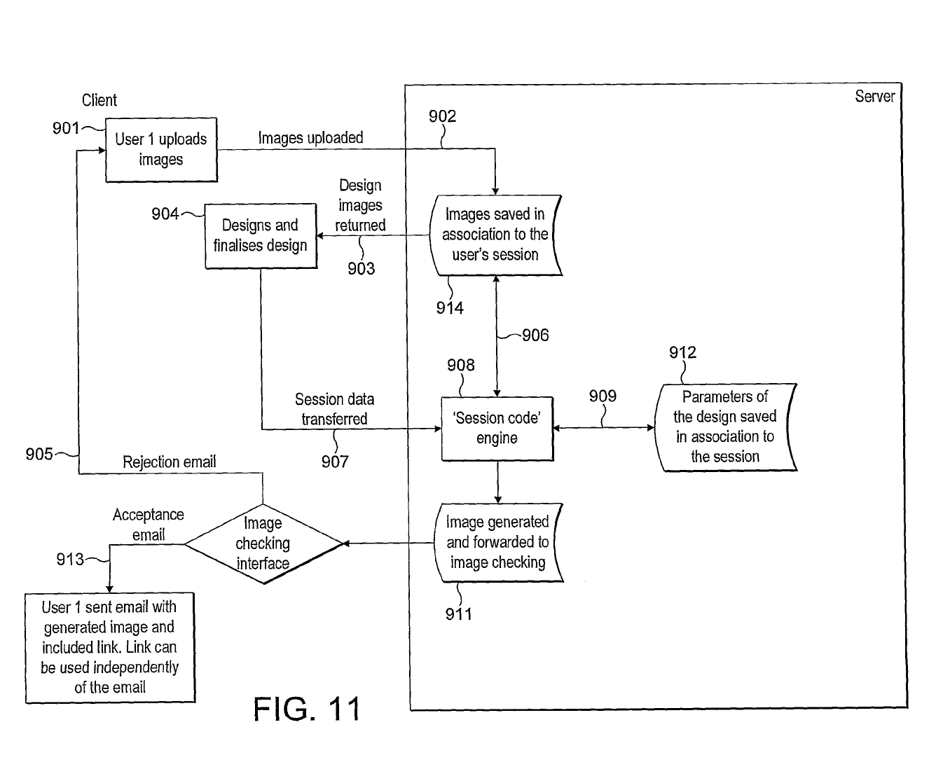

As illustrated in FIG. 11, the process beings on the clients machine 901, images may be uploaded 902, or may be simply selected from a pre-populated gallery. Either way the images are saved on the server 914. The User is then returned an image 903 and designs the card 904. The session data associated with the User is transferred 907 and held in conjunction with the other data (transfer 906) on the session code engine 908. The parameters of the designs are saved with the session identifier at 912.

This is the end of the user process as far as the session and parameters are concerned. Note however that typically an image address will have been requested of the user so that the image can be accepted/rejected and the result communicated back to the client.

The image is created 911 and checked (typically through a web based interface) and an email sent out. The rejection will simply say ‘try again’and very likely contain no session information.

The acceptance email 913 however will contain a hyper link which includes data that can be related back to the initial user (the data might be included as a querystring (GET) or post information). The email will very likely also include a version of the image-created.

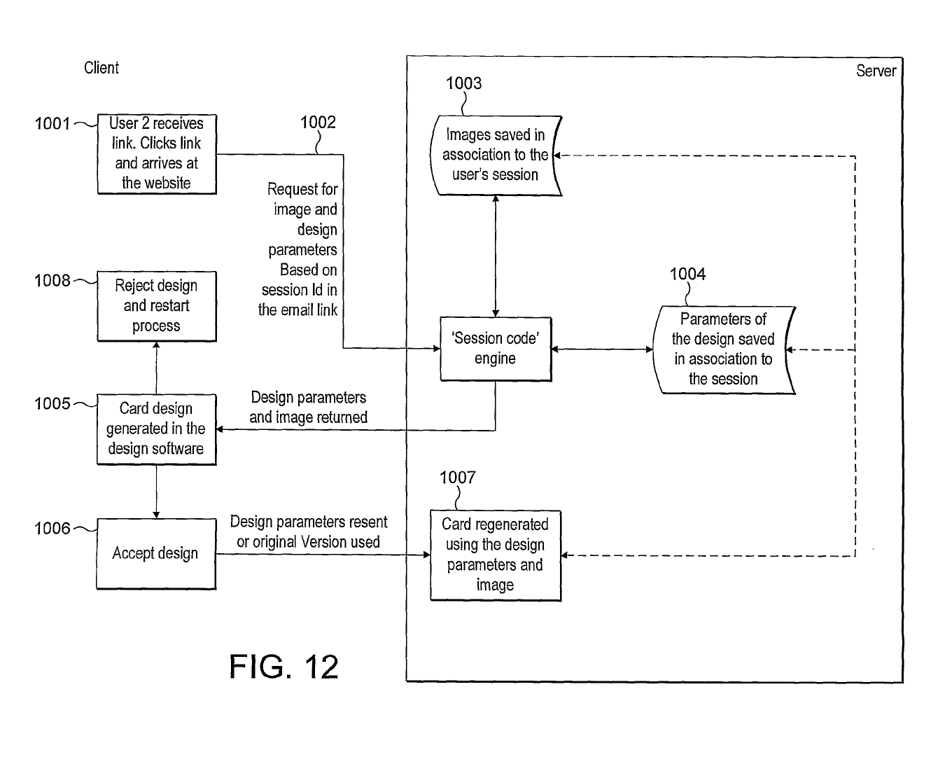

FIG. 12 illustrates the ‘friends’ process. On receipt of the link—it may be passed by email as shown here but other methods such as Instant Messenger and others are equally possible—the friend clicks the link 1001. The image and parameters are requested using this link from the image database 1003 and parameter/session database 1004.

Via the session code engine the design parameters and the image are returned (based on the identifier supplied in the link) to the friend 1005. At this point the user (friend) can reject the previous session or accept the design. This ensures that the image that is being forwarded has been checked and thus there is no brand risk associated i.e. additional images uploaded by the user are not returned to the friend (note they can be unchecked and the other images can all be supplied but this will have a brand risk for the issuer).

If the user accepts the design 1006 the card need not be re-checked as it has already been checked so it is either re-generated 1007 or potentially the original is reused. Either way the image is ready for printing at this point.

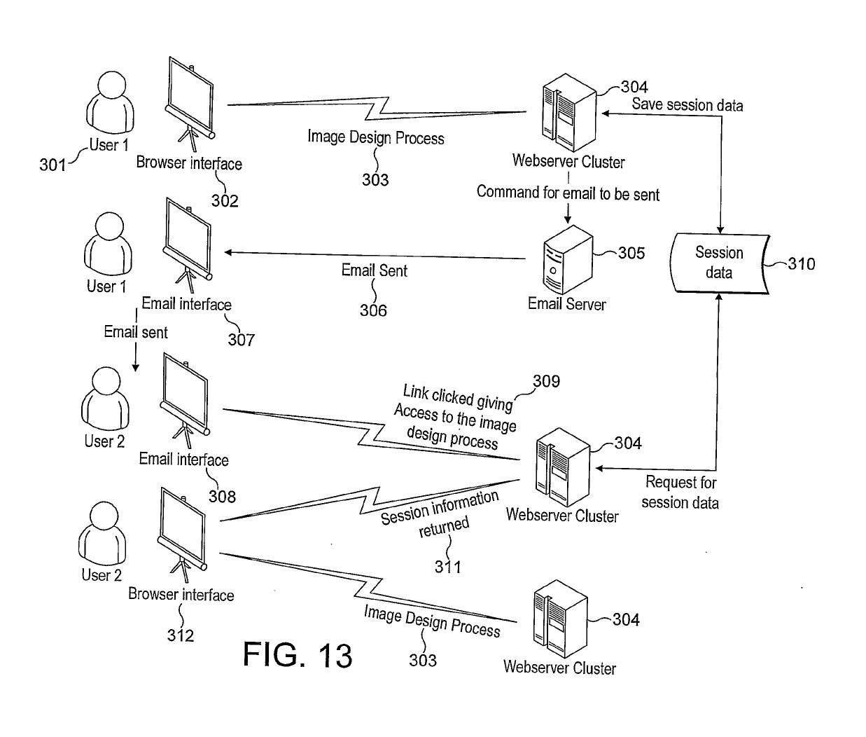

FIG. 13 give an overview of the flows between client/server and the User 1 and Friend (User 2).

An additional embodiment allows for a code to be sent within the email (typically the ‘acceptance’ email). This code may look like the following:

‘<object width=′300′ height=′220′>
<param name=′movie′value=′http://anzau.cardpix.com/minidesigner/designer.swf′>
</param>
<embedsrc=′http://anzau.cardpix.com/minidesigner/designer.swf′type=′application/
x-shockwave-flash′ width=′300′ height=′220′> </embed>
</object>

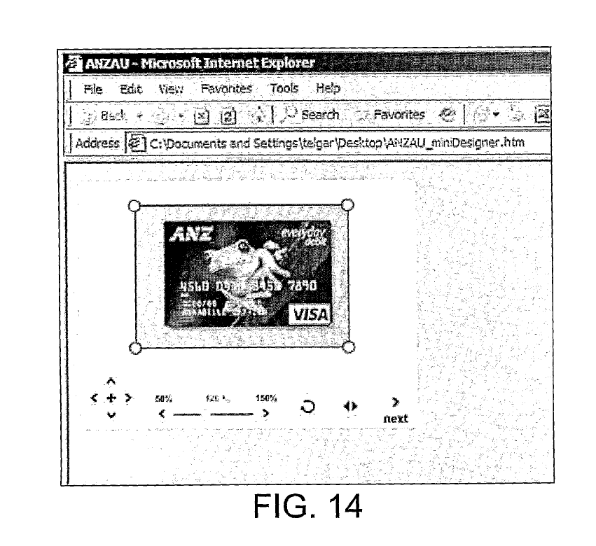

This is a code calling for a Flash movie to be embedded within a webpage—the flash movie can be functionally similar to that outlined in PCT/GB04/000626 incorporated herein by reference but, by default, imports the user's image. It creates an interface like that included as FIG. 14. The code can be posted on to a website or blog and the designer functionality is ‘served up’ from the ASP server. The friend on the blog can ‘play’ with the design and click Next to be forwarded to the website—typically with a link that retains a link through to the user's session and retain elements of the previous session as outlined above.

### Embodiment 3

Embodiment 3 is a card customization system that is used within the context of an affinity card program or similar online.

An affinity group scheme is described in GB0615735.8, which is incorporated herein by reference. An affinity group is a group such as a charity or an organisation which has a plurality of members. Examples of affinity groups are the National Trust, Cambridge University and New York University.

In such an affinity group scheme, it is desirable for an affinity group financial transaction card to be created. Members of the affinity group can then apply to receive the affinity group financial card which has a pre-designed affinity group card image thereon. For example, a member of the National Trust may apply for an National Trust credit card which has an image of one of the National Trust castles on it and/or the National Trust logo.

A card image management system is described in U.S. Ser. No. 60/852,506, which is incorporated herein by reference.

By using tools outlined in GB0615735.8 or U.S. Ser. No. 60/852,506 an user is able to access a webpage. On this webpage (which for explanatory purposes may belong to an Affinity—such as a Car club) the user can either pick from a pre-set list of ‘stock designs’ (created by the Issuer or the Affinity) or can ‘design their own’.

Thus the customized designer is accessed through an affinity site or maybe an email link sent out to members of the affinity. In any case the user will arrive on the designer site with information that may include parameters (held in the URL for example) that will allow the designer to format: the card template (to include affinity elements or card association elements), image gallery (images offered to the user if they do not wish to upload their own image) and other branding elements (such as the banner). This information may be handed in to the designer in a form such as:
www.designer.com/?affinity=12&productID=342

The user may be assigned an ID to go with their card choice either before or after this point.

If the user designs a card (and particularly if they have uploaded their own image to do so) they will be offered the opportunity to share the design with other members of the affinity. By clicking on this link the user can assign the card design to be placed underneath (typically) the other ‘stock’ card designs.

The key elements here are that the image when it is placed on a card choice page with the link embedded within it (in order to allow its choice on the way to the application page) will have a ‘card ID’ associated with it—i.e. an ID that is related only to that design and not to its creator (and very likely an affinity ID too). The user will very likely have a Unique User ID associated with themselves but this is not related to the Card image that is placed on the affinity listing page.

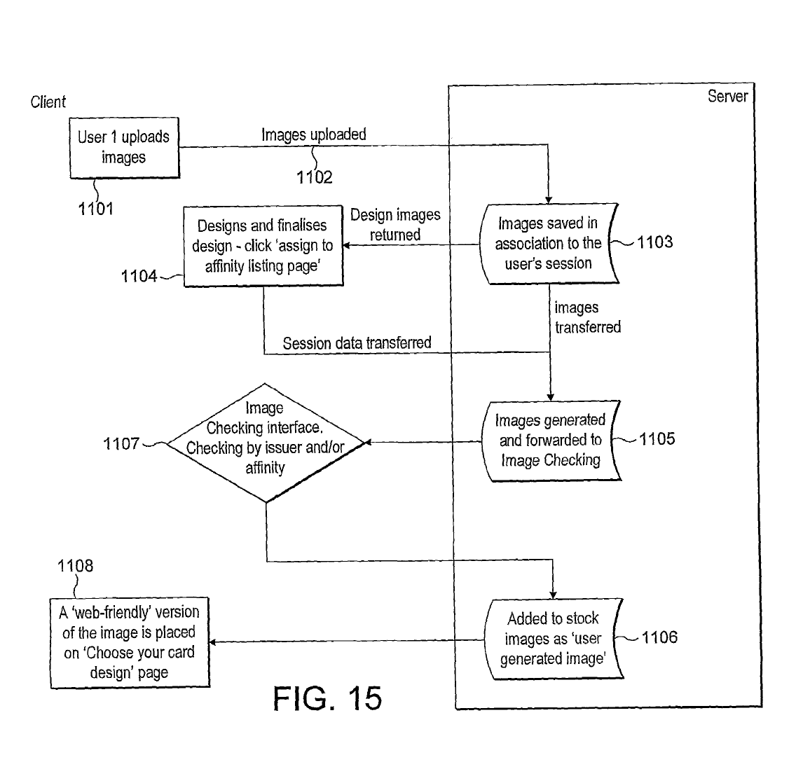

A process flow is included in FIG. 15. The process for uploading and designing the cards has been explained before—the key element of this embodiment begins at point 1105 where the card design is created using the image and the parameters selected by the user for that image. Please note it is possible always to display the card design using the image and the parameters with a graphical user interface (GUI) but this is not required in this instance. Once the image is generated it is displayed to the “image checking” facility. This facility may well have more than one type of design checker; specifically it may have representatives of both the Issuer and the Card association (Visa/Mastercard) who will both be required to supply a positive response in order for the card design to be accepted.

Also note that the image checking process and rule may be different for the Card Design for the individual (less rigorous) and for same card design once it is offered to the public and potentially for thousands of cards to be made.

If the card design is accepted for the individual then there are a number of processes by which that user can sign up for a card which will not be covered here. For the stock cards the image is placed in the stock card database which will have both web ready and printer ready images (the printer images may be stored locally to the printer). If a friend (or a fellow affinity group member or other third party) enters the site then a call—by HTTP or HTTPS—is made to the server requesting the images for the affinity partner (via the webpage). Typically the images will be served 1108 with the standard image at the top each with an embedded card design identifier so that the card choice can be tracked if the card is chosen. Below a line on the page maybe saying ‘Cards from our Members’ will be a list of card designs. Within Hypertext reference for each image will be included at least the CardDesignID for that design.

Now the friend can select the link and continue with their card sign up process.

### Embodiment 4

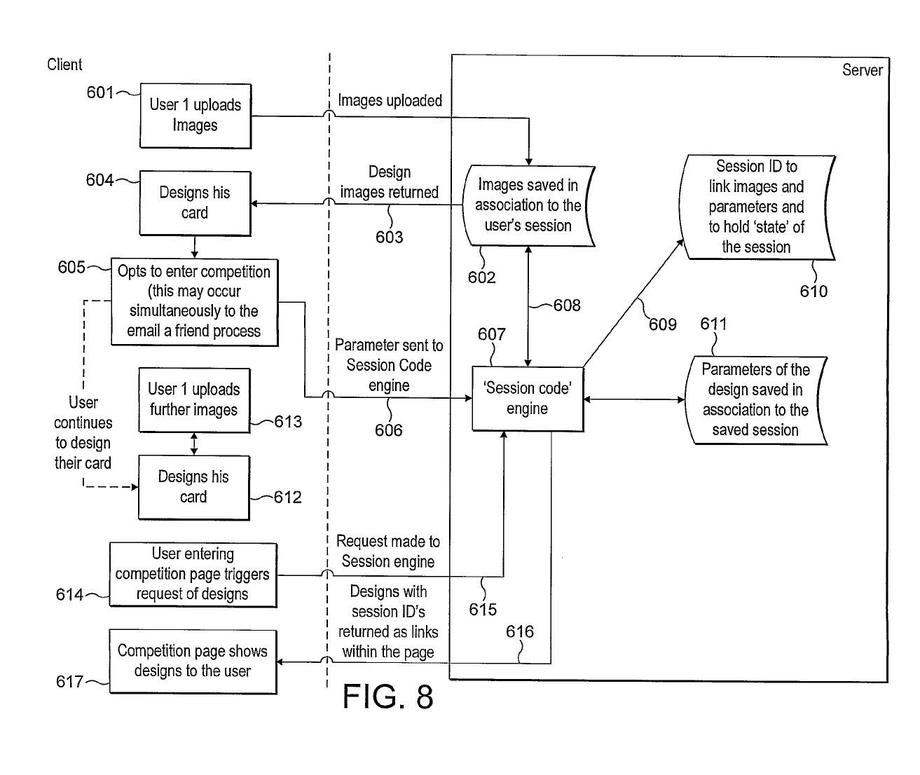

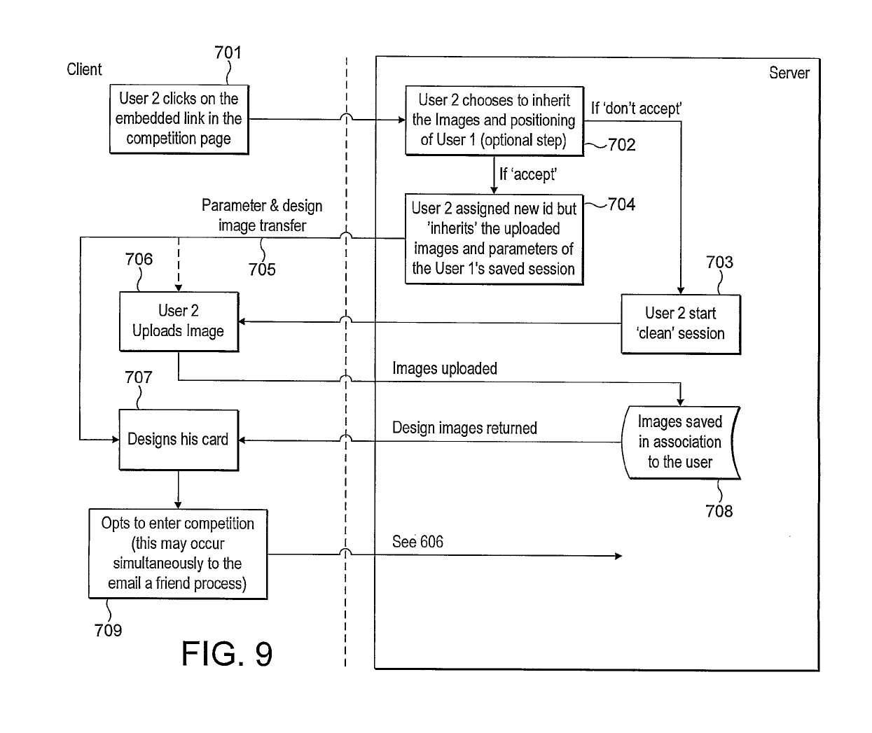

This embodiment is appreciated with reference to FIGS. 8 and 9.

In a preferred embodiment the “Send to a Friend” email can be integrated with a competition system. In this embodiment the User 101 would be able to select “Enter the Competition”. This parameter would be saved in the session store as a parameter of the session. If this parameter was set then:
1. The design would be made available to the competition site—which could be viewed by others.
2. The email to a friend would include a link “Vote for this design” and another link “View all competition designs”.

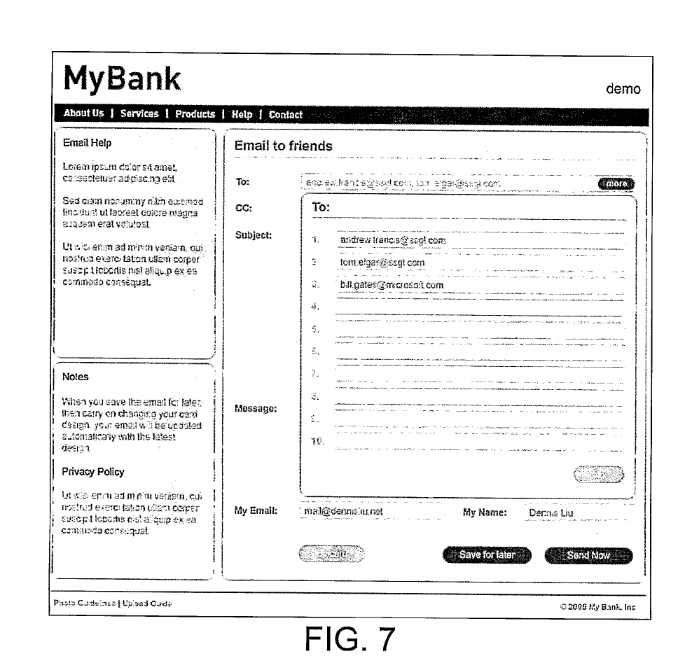

This would open a browser that would have a web page similar to FIG. 7.

This page would give the opportunity to:
1. Vote on a design type—this information would be stored in relation to the design;
2. Add a comment to a design—this may or may not trigger an email to the original designer;
3. Inherit a design and thereby use the design—the link would have a saved session that would return all the parameters for the original design (not the design session) to the User. As with the emailer the design that the User inherits would not be the original saved design but a copy thereof;
4. Inherit the previous designer's entire session—the link would have a saved session that would return all the parameters for the original design session to the User. As with the emailer the session that the User inherits would not be the original saved session but a copy thereof.

The viral nature of this process is best driven through the acceptance email which can include a link to the users image within the competition (where others can vote for the design). This allows the user to forward the link to friends ‘Vote for me!’. The methods for displaying the images and voting are laid out below which shows an API that would allow all of the basic required ‘methods’ for generating a competition. This is an Application Programmer Interface—to those skilled in the art this would say all that is required to create a competition site.

The API is comprised of the following parts: Public Image URLs and API Methods.

The Public Image URLs provide public, unrestricted access to the card images in a variety of formats and layouts.

The API Methods allow access to the data related to the images and are only accessible by authorized parties.

API Methods

The API uses a REST style interface for calling the methods where each call is performed by requesting a certain web URL containing specific parameters. The response is always an XML document which is simple enough to be parsed either with an XML library or with string pattern matching techniques.

Some of the methods included allow the competition site to:

List images in chronological order;

Add votes for specific images;

Obtain detailed information for specific images;

Count the number of images available;

List the top voted images.

All the methods require the use of a valid API Key which can be obtained from Serverside Group Limited.

This restricts access to data to authorized parties only. To ease the development of competition sites, the API includes convenient features such as the use of CAPTCHAs to prevent automated voting and automatic paging of the lists of images.

Public Image URLs

The card images can be accessed publicly without any restrictions. This means that the competition site does not need to request the images from the API on behalf of the Users. The images are available on the following formats and layouts:

Small image (241×153 pixels) including all card elements such as embossing, logos and hologram.

Large image (1013×638 pixels) without any card elements: this is just the image chosen by the User with any manipulations applied (i.e., flipped, rotated, etc).

Large image (1013×638 pixels) including all the card elements (same as the 1st item).

Large card template (1013×638 pixels) containing just the card elements over a transparent background.

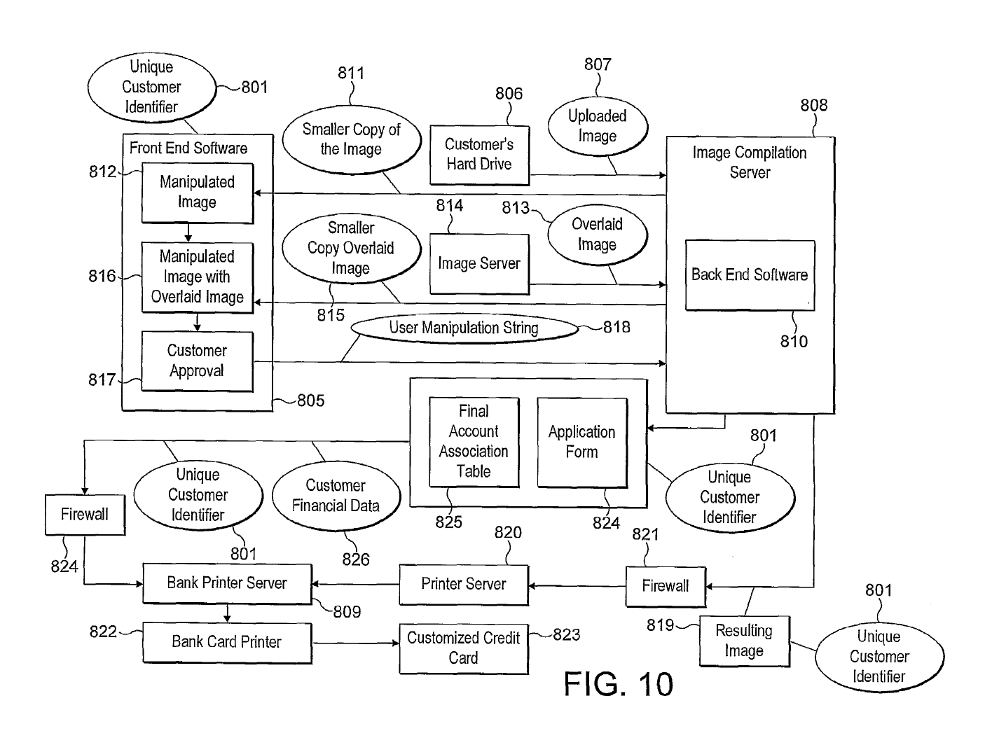

As detailed above FIG. 10 illustrates that a customer accesses software, according to the invention, having arrived at the card personalisation website 805. In the first step, the card issuer issues the customer with a unique identifying number 801 which is passed to an image compilation server 808, which may (or may not) be operated by a company other than the card issuer. The unique identifying number may be generated at this point or may be obtained from an email link—such as the send to a friend functionality or a save until later functionality. The customer then enters the front end software 805.

The user then follow the process detailed above to create a card design.

The users application 824 for the card will typically take place after the design stage to ensure that the system can be open and allow for forwarding of links and thereby viral marketing. The association of the financial details and the image are performed in a financial account association table 825 maintained in an environment that is secure from the user interface. The associated customer identifier 801 and financial data 826 are passed to a bank (or other card issuer) printer server 809 via a firewall 824.

### EXAMPLES

Small Business

Tom and two other partners own a computer consulting firm called “Peartree” which has 40 employees. Tom is not looking to apply for a new company card, nor is he necessarily the decision maker for new cards but he sees an advert online for a personalized business credit card and clicks through.

Tom uploads a company logo just to see how it looks and then adds a couple of photographs of the team to the designer. The photos are OK but the new company logo looks great—he can see himself using the card with clients and it reflects well on his business.

Tom is not really looking for a credit card but he likes the idea of a “Peartree” credit card so he sends the designer with the logo in place to the other partners (Dick & Harry).

Harry is a bit of comedian and immediately uploads a picture of Tom and Dick at the Holiday Party wearing silly hats and sends the designer back to Tom & Dick.

Dick thinks Harry's design is ridiculous but can't help laughing. He likes Tom's original design but prefers a version of their logo that has a tag line as well. He returns his newly created design back to his partners.

At this stage the partners agree that Dick's design is the best. They decide that they would like to have a card with their shared design and Tom is charged with filling in the application form. They apply for cards for all three partners and for each of their ten sales associates.

Neither of Tom, Dick or Harry discussed the financial offering until they had decided that they would take the card.

Consumer Youth Market

Jenny and Sarah are great friends—they talk everyday on the phone or by chatting online. They have recently returned back to school after a Spring Break in the Caribbean. Jenny is an avid photographer so when she sees an online ad featuring a way to personalize your debit card with a competition for the best card design she takes a look.

Whilst designing her card, Jenny uploads several recent images from their vacation but can't decide which to choose. She emails the designer to Sarah and then calls her to confer.

Sarah is always online! While they're talking she uploads a couple of great images that she had taken on their vacation too. They then realize that what would be really cool though is an older picture of Jenny's that she used to have on her desktop. It's a picture of Jenny and Sarah surfing on a summer afternoon that just looks great.

Jenny searches for the image, uploads it and sends that design to Sarah too. Sarah agrees that the design is really great and thinks of maybe getting a card herself.

Later that day a mutual friend calls Sarah and during their conversation Sarah talks about the design—she forwards the email to her friend.

Co-Brand

A Star Wars co-brand Visa credit card is launched with an enormous library of Star Wars images. Every film is represented and many animation extras as well.

Jim is a member of forums.starwars.com and very active on the message boards. He is sent an email by the official Star Wars website as part of their promotion. When he clicks through to the gallery he can barely believe his eyes; there are hundreds of images to choose from, all of which can be scaled, moved and rotated as he chooses.

Jim immediately goes to the Star Wars forum and starts a thread about which image is best. He includes his preferred design in the submission.

Jim has suggested a scene from the bar towards the beginning of the original film and has “zoomed in” in one of the characters in the background. Immediately his suggestion is lambasted and posts are received promoting images in the gallery ranging from Princess Lea to Jar Jar Binks. All with lengthy explanations as to why their particular design is preferable and the reactions they'll get at the checkout. Replies start to come in.

The Star Wars card has gone viral.

The authentication process described in PCT/GB07/000239, which is incorporated herein by reference may be used in conjunction with an emailer to share images and designs with a ‘friend’.

When a user connects to a login interface (also termed the web “admin picture” application), the login interface comprises a first login screen which for example prompts a user to input a username, which is a unique identifier corresponding to the user, and in response thereto, an application service provider (ASP) accesses at least one previously stored image that belongs to that user from an image storage area.

A plurality of images are then displayed to the user. Some of the images are those previously uploaded to the image storage area and belonging to the user mixed with other randomly selected images to provide a selection set of images displayed to the user by the ASP. The user must then select from the plurality of images those that are considered by the user to belong to him/her. The user does this by recognition of each image belonging to themselves from the set, which includes those images randomly selected from a pool of images (and are thus unrecognisable images), and selecting therefrom the image or images recognisable as their own. If the user selects the right images, they are authenticated by the system. Once the user is authenticated, they are redirected for example to a main application. For example, the card designer application.

Those skilled in the art will appreciate that while the foregoing has described what is considered to be the best mode and, where appropriate, other modes of performing the invention, the invention should not be limited to the specific configurations and methods disclosed in this description of the preferred embodiment. Those skilled in the art will recognise that the invention has a broad range of applications, and that the embodiments may take a wide range of modifications without departing from the inventive concept as defined in the appended claims.

1. A computer implemented image design facility capable of supporting image design by a plurality of users each having browser-based access, comprising:
an image design engine capable of presenting an image design interface to a plurality of users via browser software on user computers, said image design engine comprising means for storing image designs resulting from a plurality of user design processes as a corresponding plurality of uniquely identifiable sessions; and
a messaging engine to construct an electronic message to a new user identified by an existing one of said plurality of users, said messaging engine being coupled to said image design engine such that it receives session information relating to an image design produced by said existing user and intended by that user to be accessed by said new user.

2. The computer implemented image design facility according to claim 1, further comprising:
an image store for storing base images; and
an image parameter store for holding image manipulation parameters defining manipulations applied to the image during image design sessions of users.

3. A method of designing an image involving a plurality of users each having access to an image design facility via a browser-based interface on a user computer, the method comprising:
providing a first user with browser-based access to the image design facility in a first session;
receiving an indication of one or more new users from said first user with whom the first user intends to share an image design of said first session;
generating a saved session defining said image design of said first session; and
automatically generating an electronic message to said one or more new users, the or each message comprising a link to said image design facility and saved session information capable of directing the or each new user to the image design of said first user as defined in said saved session.

4. The method according to claim 3, wherein a product of a design session is stored in a form comprising a base image component and separate image manipulation parameters, the combination of which defines the designed image.

5. The method according to claim 4, wherein the base image component and the separate image manipulation parameters are linked by association with a unique identity of the session.

6. The method according to any one of claims 3 to 5, wherein the saved session has a unique session identity which is independent from a unique session identity of the first user session.

7. The method according to any one of claims 3 to 5, wherein the saved session is generated responsive to an indication the first user intends to share an image design with a new user.

8. The method according to any one of claims 3 to 5, wherein the or each new user accessing the image design facility responsive to receipt of an email is provided with a further unique session identity such that the or each user can independently define an image design to be shared with other users.

9. The method according to any one of claims 3 to 5, wherein a session comprises an open session or a saved session, and wherein a saved session holds the state of a previously open session.

10. The method according to claim 9, wherein the saved session may be used as the basis of a subsequently opened session.

11. The method according to claim 10, wherein the subsequently opened session is associated with a new unique identity.

12. A method for designing the fascia of a transaction card over a communications network, the method comprising:
opening a first design session between a first user terminal and a host computer over the communications network;
sending a first set of commands in the first design session from the first user terminal for affecting a computer program executed on a host computer for designing the fascia;
assigning an identifier for identifying said first session; and
forwarding the identifier to a second user terminal for opening a second session for affecting the fascia designed in the first session.

13. A server for hosting a user interface arranged to interact with a plurality of user terminals for designing a fascia of a transaction card, the server comprising:
means arranged to receive instructions from the user terminals;
means for establishing a first session with at least one of the user terminals and for executing the instructions received therefrom for designing a fascia;
a database for storing a copy of data corresponding to the design of the fascia in the first session;
a generator for generating a link to the copy of the data of the first session; and
a messaging engine for forwarding the link to at least one other user terminal for enabling the at least one other user terminal to access the copy of the data of the first session for designing a fascia.

14. A data structure in a database for storing data relating to a plurality of designed images, the database comprising:
a first store for storing a plurality of base images;
a second store for storing sets of parameters, each parameter set defining manipulations applied to a base image; and
a session identifier store associating a session identifier with at least a base image and a set of parameters, which combination defines a designed image.

15. A method of designing an image comprising emailing a link to a stored session, the method comprising:
establishing a first session with a first user terminal, wherein image design data is generated in response to commands from the first user terminal;
storing an email address of an email account belonging to at least one other user;
storing said image design data as well as storing a copy of said image design data; and
generating a link identifying the copy of said image design data in an email to said email account.

16. A method of accessing image design data in a saved session responsive to receipt of an electronic message to a new user comprising a link to said image design data, the method comprising generating a new session based on said saved session and allocating a new session identifier to said new session.

17. The method according to claim 16, wherein a new session based on said saved session is generated for each new user and each new session is provided with an independent session identifier.

18. The method according to claim 16 or 17, wherein sessions related to a given electronic message are related to each other in a database.

19. A method of proliferating competitive image designs, comprising:
providing a first user with browser-based access to an image design facility;
receiving an indication of one or more new users from said first user with whom the first user intends to share an image; and
generating an email including a link to, or representation of, the first user's image, said email further including a link to, or representation of, further competitive images.

20. A computer implemented image design facility capable of supporting image design by a first user having browser-based access, the image design facility comprising:
an image design engine capable of presenting an image design interface to the first user via browser software on the first users computer, and comprising a storage device for storing first user image design data produced by the first user during a first image design session; and
a messaging engine coupled to the image design engine such that it receives the first user image design data, and capable of constructing an electronic message to a second user identified by the first user, the electronic message comprising a link enabling the second user to access the first user image design data.

21. The computer implemented image design facility according to claim 20, wherein a first session identifier is associated with the first user image design data.

22. The computer implemented image design facility according to claim 21, wherein the storage device further comprises:
a session identifier store for storing the first session identifier.

23. The computer implemented image design facility according to any one of claims 20 to 22, wherein the first user image design data comprises:
image data defining a base image; and
image parameter data defining manipulations applied to the base image during the first image design session.

24. The computer implemented image design facility according to claim 23, wherein the storage device further comprises:
an image store for storing the base images; and
an image parameter store for storing the image parameter data.

25. The computer implemented image design facility according to claim 23, wherein the image parameter data comprises x and y positioning data, scale data, flip data and/or rotation data

26. The computer implemented image design facility according to claim 23, wherein the base images comprises stock images and/or uploaded images uploaded by the first user.

27. The computer implemented image design facility according to any one of claims 20 to 22, wherein the storage device further comprises:
a user address store for storing an address of the second user identified by the first user.

28. The computer implemented image design facility according to any one of claims 20 to 22, wherein the electronic message is an email.

29. The computer implemented image design facility according to any one of claims 20 to 22, wherein the electronic message is an Instant Message.

30. The computer implemented image design facility according to any one of claims 20 to 22, wherein the electronic message is SMS.

31. The computer implemented image design facility according to any one of claims 20 to 22, wherein the messaging engine is capable of generating a version of the first user image design based on the first user image design data for inclusion in the electronic message.

32. The computer implemented image design facility according to claim 31, wherein the version of the first user image design is a web friendly version of the first user image design.

33. The computer implemented image design facility according to any one of claims 20 to 22, wherein the link enables the second user to access the computer implemented image design facility and edit the first user image design during a second image design session to produce a second user image design.

34. The computer implemented image design facility according to any one of claims 20 to 22, wherein the link enables the second user to access the computer implemented image design facility and create a second user image design during a second image design session.

35. The computer implemented image design facility according to claim 33, wherein a second session identifier is associated with the second user image design.

36. The computer implemented image design facility according to claim 35, wherein the first user image design data includes data relating the second session identifier to a first session identifier associated with the first user image design data.

37. The computer implemented image design facility according to claim 33, wherein accessing the link generates the second session identifier.

38. The computer implemented image design facility according to claim 33, wherein the electronic message comprises the second session identifier generated by the messaging engine.

39. The computer implemented image design facility according to claim 35, wherein the second session identifier is related to the first session identifier.

40. The computer implemented image design facility according to any one of claims 20 to 22, wherein the link is embedded in the electronic message.

41. The computer implemented image design facility according to any one of claims 20 to 22, wherein the link is encrypted.

42. The computer implemented image design facility according to any one of claims 20 to 22, wherein accessing the link generates the first image design using image data defining a base image and image parameter data defining manipulations applied to the base image during the first image design session.

43. The computer implemented image design facility according to any one of claims 20 to 22, wherein the link enables the second user to access images uploaded by the first user.

44. The computer implemented image design facility according to any one of claims 20 to 22, wherein the first user image design is a non-finalised first user image design.

45. The computer implemented image design facility according to any one of claims 20 to 22, further comprising:
an accept/reject unit for determining if the first user image design is acceptable, and if the first user image design is not acceptable, then the message engine generates an electronic message to the first user informing the first user that the first user image design is not acceptable.

46. The computer implemented image design facility according to any one of claims 20 to 22, wherein the first user image design is applied to a transaction card.

47. The computer implemented image design facility according to claim 33, wherein the second user image design is applied to a transaction card.

48. A computer implemented message engine for constructing an electronic message to a second user identified by a first user, said computer implemented message engine comprising:
an electronic message generation unit for generating the electronic message comprising information relating to a first user image design produced by the first user for access by the second user.

49. The computer implemented message engine according to claim 48, further comprising
an image generation unit for generating a version of the first user image design based on first user image design data and including the generated version of the first user image design in the electronic message.

50. The computer implemented message engine according to claim 48 or 49, wherein the information relating to a first user image design comprises a link enabling the second user to access the first user image design.

51. The computer implemented message engine according to claim 48 or 49, wherein the information relating to a first user image design comprises image data defining a base image, and image parameter data defining manipulations applied to the base image during a first image design session.

52. The computer implemented message engine according to claim 50, wherein the information relating to a first user image design further comprises a first session identifier.

53. The computer implemented message engine according to claim 48 or 49, further comprising:
a session identifier unit for generating a second session identifier associated with the second user.

54. The computer implemented message engine according to claim 53, wherein the second session identifier is related to the first session identifier.

55. The computer implemented message engine according to claim 48, wherein the first user image design is applied to a transaction card.

56. A method of designing an image involving a plurality of users, the method comprising:
providing a first user with access to an image design facility for creation of a first image design and associating a first session identifier with the first image design;
providing a second user with access to the image design facility and information relating to the first image design associated with a second session identifier;
enabling the second user to edit the first image design associated with the second session identifier to produce a second image design; and
enabling the first user to edit the first image design associated with the first session identifier.

57. The method of designing an image according to claim 56, wherein the first image design comprises image data defining a base image, and image parameter data defining manipulations applied to the base image by the first user.

58. The method of designing an image according to claim 56 or 57, wherein the second image design comprises image data defining a base image, and image parameter data defining manipulations applied to the base image by the second user.

59. The method of designing an image according to claim 57, wherein the image data and the and image parameter data are associated with the session identifier.
